(19) United States
(12) Patent Application Publication
(10) Pub. No.: US 2012/0027007 A1
(43) Pub. Date: Feb. 2, 2012

(54) CABLE MODEM AND NETWORK REGISTRATION METHOD

(75) Inventors: YEW-MIN LO, Taipei (TW); LU-MENG HSU, Taipei (TW)

(73) Assignee: HON HAI PRECISION INDUSTRY CO., LTD., Taipei (TW)

(21) Appl. No.: 12/878,960

(22) Filed: Sep. 9, 2010

(30) Foreign Application Priority Data
Jul. 30, 2010 (CN) 201010241321.2

(51) Int. Cl. H04L 12/66; H04B 1/38

(52) U.S. Cl. 370/352; 375/222

(57) ABSTRACT

A network registration method of a cable modem boots the cable modem with a default packet cable (PC) protocol, detects the network server through a network when the cable modem is booted, and determines whether the network server has been detected. When the network server has been detected, the method registers the cable modem on the network server through the network. Additionally, the method reboots the cable modem with a backup PC protocol upon the condition that the network server has not been detected.

### BACKGROUND

1. Technical Field

Embodiments of the present disclosure relate to modems, and more particularly to a cable modem and a network registration method of the cable modem.

2. Description of Related Art

Packet cable (PC) protocols are important protocols of cable modems to provide multimedia service over internet protocol, such as voice over internet protocol (VoIP) service. There are various PC protocols, such as PC 1.0, PC 1.5, and PC 2.0.

Media gateway control protocol (MGCP) and session initiation protocol (SIP) are two important protocols for VoIP service. However, because MGCP and SIP respectively correspond to different PC protocols, they are incompatible with each other. For example, MGCP corresponds to PC 1.0 or 1.5 but cannot work with PC 2.0, and SIP corresponds to PC 2.0 but cannot work with PC 1.0 or 1.5.

Generally, PC protocol of a cable modem is either PC 2.0, or PC 1.0 or 1.5, which are determined by the protocol of a communication network of the cable modem. In detail, if the communication network uses MGCP to provide VoIP service, the cable modem must use PC 1.0 or 1.5. If the communication network uses SIP to provide VoIP service, the cable modem must use PC 2.0. Therefore, when the protocol of the communication network has changed, the cable modem cannot register on a network server of the communication network for communication using the communication network, and a new cable modem configured with a correct PC protocol is required, which causes inconvenience and is expensive.

### BRIEF DESCRIPTION OF THE DRAWINGS

FIG. 1 is a schematic diagram of the environment of one embodiment of a cable modem of the present disclosure.

FIG. 2 is a block diagram of one embodiment of the cable modem of FIG. 1.

FIG. 3 is a flowchart of a network registration method of the cable modem of the present disclosure.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

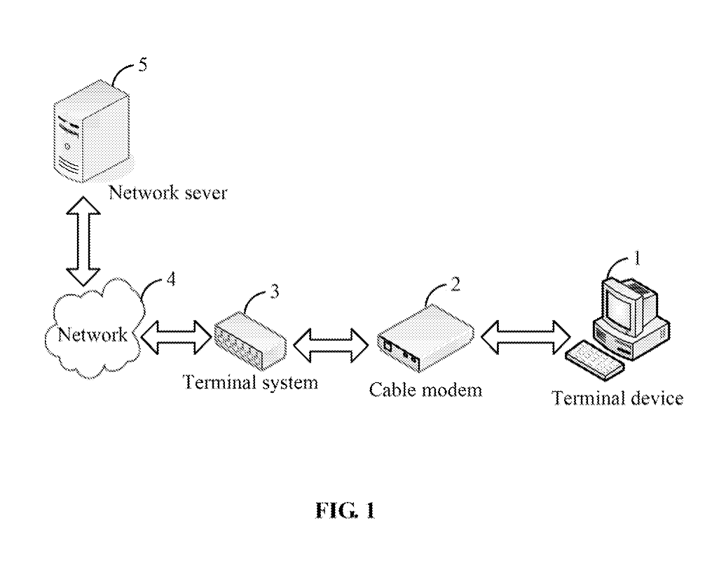

FIG. 1 is a schematic diagram of the environment of one embodiment of a cable modem 2 of the present disclosure. In the embodiment, a terminal device 1 communicates with the cable modem 2 when the terminal device 1 is booted, and connects to a network 4 through the cable modem 2 and a terminal system 3, to communicate with a network server 5. After that, the cable modem 2 may provide voice over internet protocol (VoIP) services for the terminal device 1. The terminal device 1 may be, for example, a computer, or an IP telephone. The terminal system 3 may be, for example, a cable modem terminal system (CMTS), or a center official (CO) accessing device, such as a CO router. The network server 5 may be a media gateway control protocol (MGCP) server or a session initiation protocol (SIP) server.

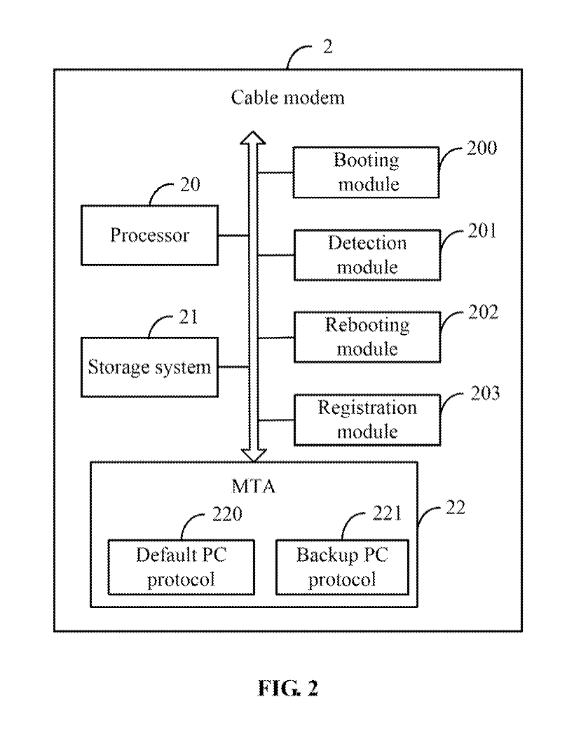

FIG. 2 is a block diagram of one embodiment of the cable modem 2 of FIG. 1. In the embodiment, the cable modem 2 includes a processor 20, a storage system 21, a multimedia terminal adapter (MTA) 22, a booting module 200, a detection module 201, a rebooting module 202, and a registration module 203. Those modules may include one or more programs stored in the storage system 21 and executed by the processor 20. In general, the word “module”, as used herein, refers to logic embodied in hardware or firmware, or to a collection of software instructions, written in a programming language, such as, Java, C, or Assembly. One or more software instructions in the modules may be embedded in firmware, such as EPROM. The modules described herein may be implemented as either software and/or hardware modules and may be stored in any type of computer-readable medium or other storage device.

In one embodiment, the cable modem 2 supports at least two packet cable (PC) protocols, one is PC 1.X, the other is PC 2.0. PC 1.X indicates PC1.0 or PC1.5. It is noted that the cable modem 2 may support all PC protocols along with various technology improvements. In the present disclosure, the following detailed description takes PC1.X and PC2.0 for example. The MTA 22 provides voice over internet protocol (VoIP) services for the terminal device 1. The MTA 22 includes a default PC protocol 220 and a backup PC protocol 221. In one embodiment, the default PC protocol 220 is PC1.X, and the backup PC protocol 221 is PC 2.0. In another embodiment, the default PC protocol 220 is PC2.0, and the backup PC protocol 221 is PC 1.X. Alternatively, the cable modem 2 may run with the default PC protocol 220 or the backup PC protocol 221 according to a type of the network server 5. For example, if the network server 5 is the MGCP server, the cable modem 2 may run with the PC 1.X to communicate with the network server 5. If the network server 5 is the SIP server, the cable modem 2 may run with the PC 2.0 to communicate with the network server 5.

The storage system 21 stores one or more programs of the cable modem 2. In one embodiment, the storage system 21 may be random access memory (RAM) for temporary storage of information, and/or a read only memory (ROM) for permanent storage of information. In other embodiments, the storage system 21 may also be an external storage device, such as a storage card, or a data storage medium. The processor 20 executes computerized operations of the cable modem 2 to provide functions of the cable modem 2.

The booting module 200 is operable to boot the cable modem 2 with the default PC protocol 220.

The detection module 201 detects the network server 5 through the network 4 when the cable modem 2 is booted, and determines whether the network server 5 has been detected. In one embodiment, the detection module 201 may use a Packet Internet Grope (PING) command to send a data package to the network server 5 through the network 4. After that, if the detection module 201 receives another data package sent back from the network server 5, the detection module 201 determines that the network server 5 has been detected. Otherwise, if the detection module 201 does not receive the data package from the network server 5 in a predetermined interval (e.g., every 2 seconds), the detection module 201 determines that the network 5 has not been detected.

In one embodiment, two situations may cause that the network server 5 cannot be detected by the detection module 201. One situation is that the cable modem 2 runs with the PC 1.X, but the network server 5 is the SIP server. Another situation is that the cable modem 2 runs with the PC 2.0, but the network server 5 is the MGCP server. Because the MGCP and the SIP are incompatible, the MGCP server and the SIP server respectively correspond to different PC protocols. The MGCP server corresponds to PC 1.X but cannot work with PC 2.0. SIP corresponds to packet cable 2.0 but cannot work with PC 1.X. Therefore, the network server 5 cannot be detected based on the aforementioned two situations.

The rebooting module 202 reboots the cable modem 2 with the backup PC protocol 221 upon the condition that the network server 5 has not been detected. When the cable modem 2 has been rebooted, the detection module 201 detects the network server 5 as described above.

The registration module 203 registers the cable modem 2 on the network server 5 through the network 4 upon the condition that the network server 5 has been detected. After the cable modem 2 is registered on the network server 5, the terminal device 1 can connect to the network 4 through the cable modem 2, to communicate with the network server 5.

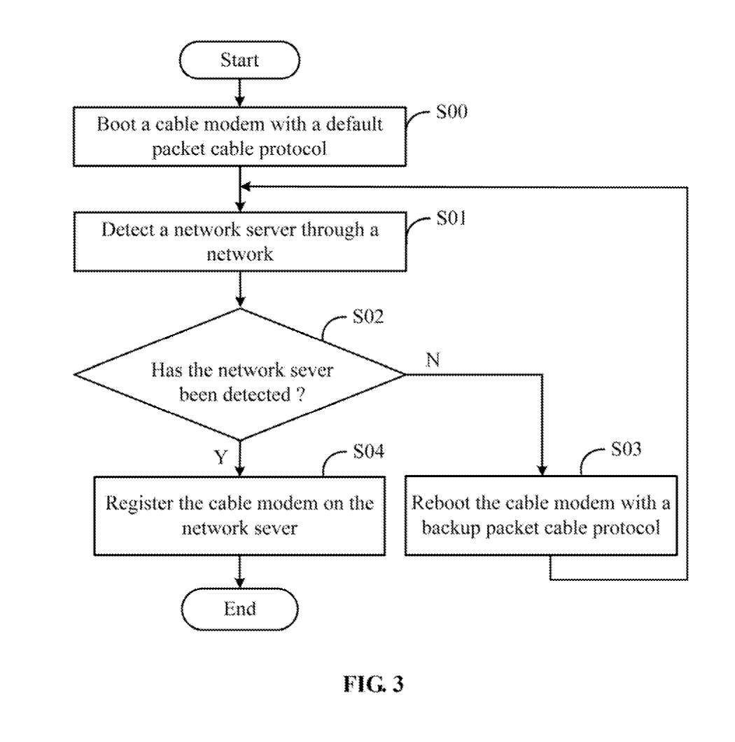

FIG. 3 is a flowchart of a network registration method of the cable modem 2 of the present disclosure. The method can control the cable modem 2 to register on the network server 5 using a correct PC protocol corresponding to the type of the network server 5.

In block S00, the booting module 200 boots the cable modem 2 with the default PC protocol 220.

In block S01, the detection module 201 detects the network server 5 through the network 4 when the cable modem 2 is booted. In block S02, the detection module 201 determines whether the network server 5 has been detected. If the network server 5 has been detected, block S04 is implemented. Otherwise, if the network server 5 has not been detected, block S03 is implemented. As mentioned above, the detection module 201 detects the network server 5 using a PING command to send a data package to the network server 5 through the network 4.

In block S03, the rebooting module 202 reboots the cable modem 2 with the backup PC protocol 221 upon the condition that the network server 5 has not been detected, and then the procedure goes back to block S01.

In block S04, the registration module 203 registers the cable modem 2 on the network server 5 through the network 4 upon the condition that the network server 5 has been detected. After the cable modem 2 is registered on the network server 5, the terminal device 1 connects to the network 4 through the cable modem 2, to communicate with the network server 5.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A cable modem in communication with a network server through a network, the cable modem comprising:
a multimedia terminal adapter (MTA) to provide voice over Internet protocol (VoIP) services of the cable modem, the MTA comprising a default packet cable (PC) protocol and a backup PC protocol;
a processor; and
one or more programs stored in a storage system of the cable modem and operable to be executed by the processor, the one or more programs comprising:
a booting module operable to boot the cable modem with the default PC protocol;
a detection module operable to detect the network server through the network when the cable modem is booted, and determine whether the network server has been detected;
a rebooting module operable to reboot the cable modem with the backup PC protocol upon the condition that the network server has not been detected; and
a registration module operable to register the cable modem on the network server through the network upon the condition that the network server has been detected.

2. The cable modem according to claim 1, wherein the detection module detects the network server by using a Packet Internet Grope (PING) command to send a data package to the network server through the network.

3. The cable modem according to claim 1, wherein the default PC protocol is PC 1.X that indicates PC 1.0 or PC 1.5, and the backup PC protocol is PC 2.0.

4. The cable modem according to claim 3, wherein the default PC protocol is PC 2.0, and the backup PC protocol is PC 1.X.

5. The cable modem according to claim 4, wherein the network server is a media gateway control protocol (MGCP) server or a session initiation protocol (SIP) server.

6. A network registration method of a cable modem, the cable modem in communication with a network server through a network, the method comprising:
providing a default packet cable (PC) protocol and a backup PC protocol for a multimedia terminal adapter (MTA) to support voice over Internet protocol services of the cable modem;
booting the cable modem with the default PC protocol;
detecting the network server through the network when the cable modem is booted, and determining whether the network server has been detected;
rebooting the cable modem with the backup PC protocol upon the condition that the network server has not been detected, and repeating the detecting step;
registering the cable modem on the network server through the network upon the condition that the network server has been detected.

7. The method according to claim 6, wherein the network server is detected by using a Packet Internet Grope (PING) command to send a data package to the network server through the network.

8. The method according to claim 6, wherein the default PC protocol is PC 1.X that indicates PC 1.0 or PC 1.5, and the backup PC protocol is PC 2.0.

9. The network registration method according to claim 8, wherein the default PC protocol is PC 2.0, and the backup PC protocol is PC 1.X.

10. The method according to claim 6, wherein the network server is a media gateway control protocol (MGCP) server or a session initiation protocol (SIP) server.

11. A storage medium storing a set of instructions, the set of instructions capable of being executed by a processor of a cable modem to perform a network registration method of the cable modem, the method comprising:
providing a default packet cable (PC) protocol and a backup PC protocol for a multimedia terminal adapter (MTA) to support voice over internet protocol services of the cable modem;
booting the cable modem with the default PC protocol;
detecting the network server through the network when the cable modem is booted, and determining whether the network server has been detected;
rebooting the cable modem with the backup PC protocol upon the condition that the network server has not been detected, and repeating the detecting step;
registering the cable modem on the network server through the network upon the condition that the network server has been detected.

12. The storage medium as claimed in claim 11, wherein the network server is detected by using a Packet Internet Grope (PING) command to send a data package to the network server through the network.

13. The storage medium as claimed in claim 11, wherein the default PC protocol is PC 1.X that indicates PC 1.0 or PC 1.5, and the backup PC protocol is PC 2.0.

14. The storage medium as claimed in claim 13, wherein the default PC protocol is PC 2.0, and the backup PC protocol is PC 1.X.

15. The storage medium as claimed in claim 11, wherein the network server is a media gateway control protocol (MGCP) server or a session initiation protocol (SIP) server.
